(19) United States
(12) Patent Application Publication
(10) Pub. No.: US 2019/0351405 A1
(43) Pub. Date: Nov. 21, 2019

(54) MODULAR SAMPLE PREPARATION SYSTEM FOR PREPARING AQUEOUS SOLUTIONS CONTAINING SOLID MATTER OF VARIOUS SALT CONTENTS AND TEMPERATURES FOR THE PURPOSE OF DOWNSTREAM MEASUREMENT

(71) Applicant: K+S AKTIENGESELLSCHAFT, Kassel (DE)

(72) Inventors: Daniel Bachmann, Ronshausen (DE); Torsten Krüger, Salem (DE); Georg Narbei, Oberrohn (DE); Eugen Reinhardt, Ratzeburg (DE); Torsten Rest, Heringen (DE); Sebastian Richter, Kassel (DE); Walter Wiegand, Kirchheim (DE)

(73) Assignee: K+S AKTIENGESELLSCHAFT, Kassel (DE)

(21) Appl. No.: 16/466,555

(22) PCT Filed: Nov. 16, 2017
(86) PCT No.: PCT/DE2017/000387

§ 371 Date: Jun. 4, 2019

(30) Foreign Application Priority Data
Dec. 5, 2016 (DE) 10 2016 123 473.7

(51) Int. Cl. B01L 3/00; G01N 1/20; G01N 1/40

(52) U.S. Cl. CPC B01L 3/502; G01N 1/2035; G01N 1/4077; G01N 2001/4088; B01L 2300/18; B01L 2300/088; B01L 2300/16; B01L 2300/0681

(57) ABSTRACT

A sample preparation device is useful for preparing a sample of a process fluid, and the device contains a removal device; a filter unit, which is designed to filter the sample of the process fluid in such a way that the filtered sample of the process fluid is substantially free of any turbidity; a feed device; and also a temperature control device, which is designed to control the temperature of the sample of the process fluid in such a way that the temperature of the sample of the process fluid is substantially constant while it is being fed.

The invention relates to a sample preparation device, with the process fluid being a turbid solution with substances dissolved therein, in particular substances of at least one salt dissolved therein. Further, the invention relates to an analysis device having such a sample preparation device with an analysis appliance.

In process technology and/or automation engineering, use is frequently made of sample preparation devices for automatically taking and processing a sample of a process fluid, said sample being taken from a process by means of a withdrawal apparatus, being processed and subsequently being supplied to an analysis appliance, or else analyzer, for determining and/or monitoring an analysis measured variable of the sample of the process fluid.

By way of example, the analysis appliances are used to measure and monitor a concentration of a certain substance, which is often dissolved in the sample and also referred to as an analyte, such as sodium, potassium, ammonium, chloride, phosphate, silicate or nitrate, for example. Here, the analyte of the substance can also be present in the form of a salt, i.e., in the form of a crystalline ionic compound. However, an analyte can also be a biological or biochemical compound.

By way of example, the analysis measured variable can be ascertained photometrically or spectrometrically by virtue of electromagnetic radiation, e.g., visible light, being radiated from a radiation source into a measuring cell of the analysis appliance containing the sample and being received by a suitable receiver, for example following transmission through the sample. The receiver produces a measurement signal depending on the intensity of the received radiation, from which measurement signal the analysis measured variable can be derived.

In a multiplicity of applications, the process fluids to be analyzed or monitored may have a certain solid component, which makes itself noticeable as turbidity. This turbidity may lead to falsification of the analysis measured variable in the case of analysis methods based on one of the aforementioned optical measurement principles or may even make a reliable measurement impossible. Moreover, relatively large particles can clog up the fluid line in which the sample of the process fluid is conveyed from the withdrawal apparatus connected thereto to the measuring appliance and/or clog up fluid lines within the analysis appliance itself.

Therefore, a sample preparation device often comprises a filter unit, which serves to filter the sample of the process fluid before the latter is supplied to the analysis appliance. A sample of the process fluid, optionally with a predetermined sample amount, is conveyed from the filtrate to the analysis appliance by means of a process technology device and said sample is treated and/or analyzed as described above in said analysis appliance.

A sample preparation device configured to intermittently rinse a filter unit of the sample preparation device by means of a cleaning medium comprising an oxidation means and thus avoid the filter clogging up is known from DE 10 2011 088 235 A1. DE 10 2014 115 594 A1 has disclosed a further sample preparation device that comprises a surface and/or device that is arranged in the flow path from the filter unit to the sample collection unit and that has a germ-reducing effect on the sample.

As a result of such a sample preparation device processing the sample in automated fashion, the analysis appliance can optionally determine and/or monitor the analysis measured variable in-line. Within the scope of this application, an in-line measurement refers to the direct measurement of a measured variable in situ in the sample of the process fluid supplied thereto without, for example, a further pretreatment of the sample being necessary. By contrast, for analysis measuring appliances not measuring in-line, a pretreatment of the sample is necessary, for example by way of the addition of reagents which only lead to a change in the sample capturable by means of the aforementioned optical analysis appliances after a certain period of time. The time offset caused thereby leads to the process tracking with an analysis measuring device not measuring in-line being subject to great inertia, and so the open-loop and/or closed-loop control of a process on the basis of an analysis measured variable not measured in line is found to be difficult.

By contrast, a sample preparation device for an in-line analysis appliance allows the analysis measured variable measured by the in-line analysis appliance to be used for open-loop and/or closed-loop control of a process. What must be ensured if the analysis measured variable is a concentration of the analyte is that the processed and filtered process fluid substantially has the same concentration of the analyte or analytes as in the process itself. The concentration should be substantially constant from the taking from the process up to the supplying to the in-line analysis appliance.

However, this is demanding from a process technological point of view if the analyte or analytes are present in the process fluid with a relatively high concentration, in particular with a concentration that is close to the saturation concentration of the respective analyte in the process fluid. Here, the saturation concentration of an analyte in a fluid depends, as a matter of principle, on the temperature of the fluid. By way of example, if there now is a drop in the temperature of the sample of the process fluid when the latter is conveyed through the sample preparation device, this change in temperature may also reduce the saturation concentration to such an extent that the concentration of the analyte in the sample lies significantly above the saturation concentration. Ultimately, this leads to the analytes dissolved in the process fluid being precipitated from the process fluid during the conveyance through the sample preparation device.

This change in the concentration of the analyte in the sample of the process fluid, caused by temperature changes, leads firstly to a systematic error in the analysis measured variable. Secondly, the precipitated analytes may clog up the fluid line of the sample preparation device. This effect increases the warmer the process fluid is in comparison with the ambient temperature and the longer the path of the sample of the process fluid is in the sample preparation device. Therefore, the temperature of the process fluid must be ensured to be constant during the conveyance of the process fluid in the sample preparing device, particularly in the case of warm process fluids (i.e., process fluids with a process temperature far above the ambient temperature) with analytes dissolved therein that have an analyte concentration in the vicinity of the saturation concentration.

Although the sample preparation devices known from the aforementioned prior art facilitate the processing of a sample of the process fluid for an in-line analysis appliance, including automated removal and filtering, the known sample preparation devices have no means for temperature control, by means of which the sample of the process fluid can be kept at a constant temperature when conveyed through the sample preparation device, in particular.

The invention is therefore based on the object of specifying a sample preparation device for processing a process fluid for an in-line analysis appliance, wherein the process fluid is a turbid solution with substances undissolved and dissolved therein, in particular with substances of at least one salt dissolved therein. Moreover, the invention is based on the object of specifying an analysis device, comprising the sample preparation device and the in-line analysis appliance.

The object is achieved by claim 1 in respect of the sample preparation device.

Claim 1 contains a sample preparation device for processing a sample of a process fluid, wherein the process fluid is a turbid solution with substances undissolved and dissolved therein, in particular with substances of at least one salt dissolved therein, comprising: a withdrawal apparatus for receiving the sample of the process fluid and a first section of a fluid line connected thereto.

Furthermore, the sample preparation device comprises a filter unit connected to the first section of the fluid line and to a second section of the fluid line, said filter unit being configured to filter the sample of the process fluid in such a way that the filtered sample of the process fluid is substantially free from turbidity, wherein the filter unit is arranged between the withdrawal apparatus and the second section of the fluid line.

Furthermore, the sample preparation device comprises a conveyor device, which is configured to convey the sample of the process fluid from the withdrawal apparatus to the filter unit by means of the first section of the fluid line and subsequently to convey said sample as a filtered sample of the process fluid from the filter unit to an end section of the second section by means of the second section of the fluid line, and wherein the filtered sample of the process fluid is suppliable by the end section to an analysis appliance that is connectable to the end section, in particular to an analysis appliance that is based on a physical, preferably optical measurement principle.

Furthermore, the sample preparation device comprises a temperature control device, wherein the temperature control device is configured to subject the sample of the process fluid to temperature control in such a way that the temperature of the sample of the process fluid remains substantially constant when conveyed through the fluid line and when filtered in the filter unit such that the temperature of the filtered sample of the process fluid in the end section that is connectable to the analysis appliance is substantially the same as a process temperature of the process fluid, which the process fluid has when the sample is taken.

Here, the process temperature denotes the temperature of the process fluid in the process. Therefore, the process temperature is considered to be predetermined within the scope of this application. By way of example, the process temperature can be known per se for the respective process, or else it can be measured at the withdrawal apparatus by means of a suitable temperature measuring appliance. Thus, the predetermined temperature is, for example, the temperature of the process, for the open-loop and/or closed-loop control of which the analysis measured variable (and optionally further open-loop and/or closed-loop control parameters) measured by the analysis device is provided.

A sample of the process fluid is taken from the process by means of the withdrawal apparatus and guided into the fluid line connected to the withdrawal apparatus. The fluid line can be one or more pipes or pipe sections and/or tubes or tube sections, which are connected to one another by way of one or more valves, for example. The materials of the sample preparation device, in particular of the fluid line and/or of the temperature control device, can be adapted to the process temperature and/or to the type of the substances dissolved in the process fluid in the respective process.

The filter unit can be a filter or a system of filters. Here, the filter unit filters solids out of the sample such that a portion of filtered and substantially not turbid sample is produced by means of the filter unit, without, however, the concentration of the analytes for the analysis appliance being influenced. Here, the filter unit has at least one supply line (the first section of the fluid line) and a discharge line (the second section of the fluid line). The materials of the filter unit, too, can be adapted to the process temperature and/or to the type of substances occurring in the respective process.

Compared to the sample preparation devices known from the prior art, the sample preparation device according to the invention is advantageous in that the concentration of the at least one substance, in particular of the at least one substance dissolved in the sample of the process fluid, remains substantially unchanged during the entire conveyance from the withdrawal apparatus to the end section. This is rendered possible by the temperature control device since the saturation concentration of the at least one substance in the sample of the process fluid, too, remains unchanged in the case of a constant temperature. As a result, no substances, in particular no salt crystals, can be precipitated, particularly for the case where the ambient temperature is lower than the process temperature.

In one configuration, the process temperature (PT) of the process fluid lies between 0° C. and 110° C. Naturally, the process temperature could also be higher, for example lie between 50° and 110°.

In one development, the temperature control device has actively heating temperature control elements and/or passive insulating temperature control elements for the purposes of keeping the temperature of the sample of the process fluid at the process temperature (PT) while conveying said sample of the process fluid. Should the ambient temperature present in the surroundings of the sample preparation device lie below (above) the process temperature, cooling (heating) of the sample of the process fluid in the sample preparation device is prevented by means of the actively heating temperature control elements and/or by means of the passively insulating temperature control elements.

By way of example, the active temperature control elements can be heating elements that are applied or are appliable to the fluid line and/or introduced into the fluid line. By way of example, the passive temperature control elements can be insulation elements, which are applied to the fluid line substantially continuously (e.g., as heating wires wound around the fluid line) or at regular intervals. Naturally, the temperature control device may also comprise at least one temperature measuring appliance for measuring the temperature at one or more points along the sample preparation device, on the basis of which the heating power of the active elements then can be adapted by means of a controller.

In a further development, the sample preparation device comprises an electronics unit for open-loop and/or closed-loop control of the withdrawal apparatus, the filter unit, the conveyor device and/or the temperature control device. By way of example, the electronics unit comprises electronics comprising a microcontroller.

In an advantageous development, the solution is present as a virtually saturated solution, a substantially saturated solution or an oversaturated solution. In particular, the concentration of at least one of the substances dissolved in the process fluid is at least 65% of the saturation concentration. The concentration of the dissolved substances in the filtered sample of the process fluid corresponds to the concentration of the dissolved substances in the unfiltered sample of the process fluid. Thus, the filter unit in this development is configured in such a way that the concentration of the dissolved substances is not substantially influenced by the filter unit, even in the case of filtering the virtually saturated, substantially saturated or oversaturated solution.

In one configuration, the conveyor device comprises a pump, in particular a speed regulated pump, arranged in the first section of the fluid line. As an alternative or in addition thereto, the conveyor device may comprise a pump, in particular a speed-regulated pump, arranged in the second section of the fluid line. Naturally, the pump arranged in the first section of the fluid line and/or the pump arranged in the second section of the fluid line may alternatively also be a non-speed-regulated pump, for example a roller pump (also: peristaltic pump), in particular in the case where the fluid line is a tube and/or interconnected tube sections.

In one development, the sample preparation device comprises at least one measuring appliance for determining and/or monitoring at least one measured variable of the sample of the process fluid conveyed through the fluid line, said measuring appliance being arranged between the withdrawal apparatus and the end section. In particular, the sample preparation device comprises at least one temperature measuring appliance, at least one flow measuring appliance and/or at least one pressure measuring appliance.

In particular, the at least one measuring appliance can also be connected to the electronics unit in such a way that the electronics unit is configured for open-loop and/or closed-loop control of the sample preparation device on the basis of the measurement values of the measuring appliance. Consequently, the sample preparation device can be regulated and/or controlled from a process point of view by determining and/or monitoring the at least one measured variable.

By way of example, a check can be carried out by means of one or more temperature measuring appliances as to whether the temperature in the fluid line corresponds to the process temperature in order, if need be, to track the heating power of the actively heating elements of the temperature control device.

By way of example, a temperature measuring appliance can be configured as a resistance-based thermometer such as a Pt100 or Pt1000, for example, or as a thermoelectric voltage-based thermometer or thermal element, or any other temperature measuring appliance known from the prior art.

A flow measuring appliance can be configured, for example, as a magnetic-inductive flow measuring appliance, as an ultrasound flow measuring appliance, as a Coriolis flow measuring appliance or as any other flow measuring appliance known from the prior art.

A pressure measuring appliance can be configured as an absolute and/or differential pressure measuring appliance. By way of example, pressure measuring appliances that operate by means of a membrane and a piezo-resistive or capacitive measurement principle, or other pressure measuring appliances known from the prior art, are suitable to this end.

Naturally, it is also possible within the scope of this development to provide a plurality of measuring appliances for the same measured variable in the sample preparation device, for example in order to measure temperature, pressure and/or flow of the sample of the process fluid at a plurality of points of the sample preparation device. It is also possible for a single measuring appliance to be configured to measure a plurality of measured variables and consequently be embodied as a multi-variable measuring appliance. By way of example, it is possible to integrate the temperature measuring appliance as a thermal element into the circuitry of another measuring appliance by virtue of material pairs for which a thermoelectric effect occurs being used for the electric supply lines in the circuitry of the other measuring appliance.

In one configuration of this development, at least one of the measuring appliances has a measuring appliance region, which is in contact with the sample of the process fluid while determining and/or monitoring the measured variable. In particular, the measuring appliance region has been coated with a protective coating. The measuring appliance region, in particular the protective layer, is configured as being resistant to the process fluid. By way of example, the following materials, inter alia, are suitable as materials for the measuring appliance region, in particular as materials for the protective layer coating the measuring appliance region: perfluoroalkoxy polymers (PFA), polytetrafluoroethylene (PTFE), glass and/or ceramics such as Al₂O₃, for example, or stainless or corrosion-resistant high-grade steels. Here, the material for the measuring appliance region, in particular the material of the protective layer, should be chosen depending on the maximum possible process temperatures, on the at least one type of substances and/or on the maximum possible concentration of the substances. As a result, the measuring appliance region in contact with the sample of the process fluid can be designed to be resistant in relation to chemical-physical attacks of the sample of the process fluid on the measuring appliance region, in particular in relation to those chemical-physical attacks that are caused by comparatively high process temperatures and comparatively high concentrations of the substances dissolved in the process fluid.

In a further development, the filter unit is configured as substantially self-cleaning, wherein the filter unit comprises an outlet, by means of which an unfiltered and turbid proportion of the withdrawn sample of the process fluid can be discharged. In this development, the filter unit according to the invention thus comprises a further discharge line (the outlet) in addition to the supply line (the first section of the fluid line) and the discharge line (the second section of the fluid line). The filter unit configured as self-cleaning is embodied, for example, as a pressure-driven membrane filter such that the self-cleaning of the filter is implemented by means of a (back) flushing process of the sample to be filtered and/or the filtered sample of the process fluid under suitable pressures.

In a further development, the sample preparation device comprises a cleaning unit. The cleaning unit comprises at least one reservoir with a cleaning medium, wherein a further fluid line is connected to the reservoir. The further fluid line is connected to the fluid line by means of a valve unit connected to the further fluid line in such a way that the cleaning medium can be guided from the further fluid line into the fluid line and the filter unit.

By way of example, the valve unit comprises one or more two-way valves and/or one or more ⅔ valves. Here, too, the valve unit can be configured to be actuatable by the electronics unit. Here, in particular, the valve unit and the control unit are configured in such a way that either the sample of the process fluid is guided through the fluid line and the filter or the cleaning medium is guided from the further fluid line into the fluid line and the filter. In this development, the sample preparation device can be put into two different modes of operation by means of the controller. In a first mode of operation (the sample taking mode), the sample of the process fluid is taken by the sample withdrawal apparatus and conveyed through the filter unit to the end section. In a second mode of operation (the cleaning mode), the feed line of the sample of the process fluid into the fluid line is blocked by means of suitable actuators, preferably actuatable by the electronics unit, such as further valve units of the sample preparation device, with the cleaning medium now being guided into the fluid line and the filter instead of the sample of the process fluid. Subsequently, the cleaning medium can be supplied back into the reservoir and/or supplied to an outlet, for example via a line that has been equipped with a further valve, for example an outlet leading to a waste container. Optionally, a further conveyor device can be provided for conveying the cleaning medium, for example one or more additional pump(s).

In a preferred configuration of this development, the cleaning medium is deionized water. The cleaning unit comprises an additional temperature control device, by means of which the cleaning medium in the reservoir and/or in the further fluid line is brought to a cleaning temperature (RT), which deviates from the process temperature (PT) by no more than 40° C., in particular by no more than 15° and preferably by no more than 5° C. Deionized water offers the advantage that possible salt residues of the cleaning medium remaining in the fluid line and hence influencing the concentration of the substances in the sample of the process fluid are precluded. The temperature control or the additional temperature control device offers the advantage that the cleaning temperature only deviates to a restricted extent from the process temperature. What is advantageous in this case is that the fluid line and the filter unit are not exposed to a temperature that is fundamentally different from the process temperature as a result thereof. By way of example, this substantially precludes too strong a cooling of the fluid line and/or the filter unit in the cleaning mode.

In a further configuration of this development, the cleaning unit has a cleaning agent reservoir connected to the further fluid line. The cleaning unit comprises, in particular, a metering unit for metering the cleaning agent supplied to the further fluid line, connected between the further fluid line and the cleaning agent reservoir.

Here, the metering unit, too, can be actuatable by the electronics unit, for example by virtue of the exact metering of the cleaning agent being able to be set by means of the electronics unit. The cleaning agent, which can be added to the cleaning medium in metered fashion, is an acid, for example.

In a further configuration, the sample preparation device comprises a prefilter arranged between the withdrawal apparatus and the filter unit. The prefilter and/or the cleaning unit are preferably configured as modular constituents of the sample preparation device. This means that the prefilter and/or the cleaning unit are flexibly and reversibly connectable to the other elements of the sample preparation device. By way of example, this makes it easier to replace the prefilter and/or renders it possible to add the prefilter and/or the cleaning unit to the sample preparation device, depending on the type of the process fluid. As a result, this makes it easy to adapt the sample preparation device if there is a change in the process or the process fluid. Here, the prefilter serves to prefilter the process fluid, for example by virtue of, by means of the prefilter, filtering out those solid particles that are larger than a certain particle size, i.e., particularly coarse solid particles, and that make the process fluid turbid.

The object is achieved by claim 14 in respect of the analysis device. Claim 14 contains a sample preparation device according to the invention. The analysis device further comprises an analysis appliance connected to the end section. The analysis appliance, in particular, is an analysis appliance based on an optical measurement principle. The analysis appliance comprises a measuring cell for in-line determination and/or monitoring of at least one analysis measured variable of the filtered sample of the process fluid supplied to the analysis appliance via the end section, wherein the at least one analysis measured variable comprises at least one concentration of substances dissolved in the process fluid, in particular at least one concentration of salt crystals dissolved in the process fluid. The combination of the sample preparation device with the measuring cell of the analysis appliance disposed downstream of the sample preparation device facilitates a downstream, substantially automatable evaluation (e.g., by means of the electronics unit).

In a development of the analysis device, the analysis appliance comprises a temperature measuring appliance for determining and/or monitoring the temperature of the filtered sample of the process fluid in the measuring cell. In this development, the temperature measuring appliance allows additional checking as to whether the temperature of the sample of the process fluid present in the measuring cell corresponds to the process temperature. The temperature measuring appliance for determining and/or monitoring the temperature of the filtered sample of the process fluid in the measuring cell can also be connected to the electronics unit of the sample preparation device in such a way that the temperature in the analysis appliance is used to adjust the sample preparation device.

In one configuration, the analysis device comprises an outlet for manually taking a sample of the filtered sample of the process fluid, said outlet adjoining the analysis appliance. Here, the sample taken manually can be supplied, for example, to a further analysis appliance not measuring in-line. Using this, it is possible in this configuration to carry out a calibration, verification and/or adjustment of the in-line analysis appliance by means of the further analysis appliance. Here, calibration is usually understood to mean determining a deviation of a first measurement value measured by the first analysis appliance from the second measurement value (reference measurement value) made available by the second analysis appliance, which is assumed to be correct, or the assignment of this reference measurement value to the first measurement value. The verification comprises the ascertainment of the deviation and the estimation or evaluation thereof. Adjustment is understood to mean adapting the first analysis appliance in such a way that a model, on the basis of which the first analysis appliance ascertains a measurement value from a raw value supplied by its measurement cell, is adapted in such a way that the measurement value thereof corresponds to the second measurement value, serving as a reference measurement value, made available by the second analysis appliance.

The invention will be explained in more detail on the basis of the following figures, with the same reference signs denoting the same features in different figures. In detail:

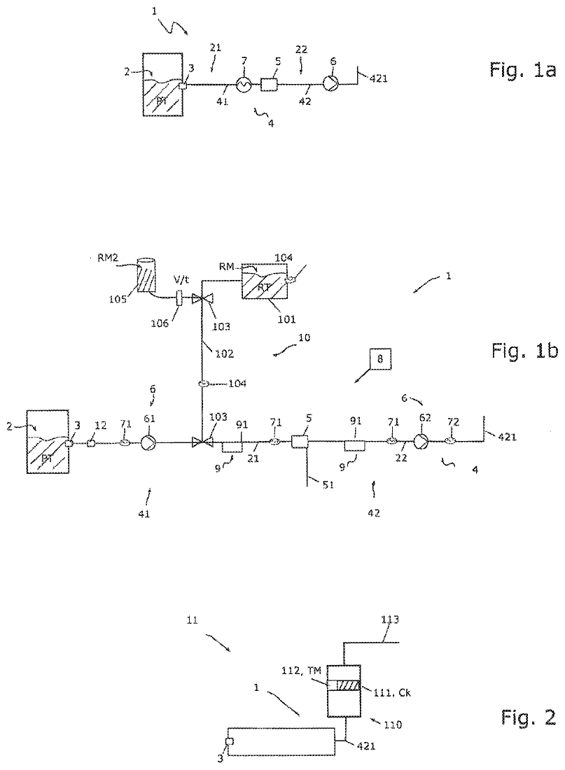

FIG. 1a shows a configuration of a sample preparation device according to the invention;

FIG. 1b shows a further configuration of a sample preparation device according to the invention; and

FIG. 2 shows a configuration of an analysis device according to the invention.

FIG. 1a shows a schematic illustration of a sample preparation device 1 according to the invention for taking/processing a sample 21, 22 of a process fluid 2. Illustrated are a process fluid 2 situated in a process, with the temperature of the process fluid 2 in the process having a process temperature PT lying between 70-110° C. and with the pressure of the fluid in the process being such in this case that the process medium is present substantially in the liquid phase, i.e., as a fluid. By way of example, the process fluid 2 is a turbid, i.e., opaque process fluid 2 such that a measurement of a sample 21 of the process fluid using an analysis appliance based on optical measurement principles, for example, is falsified or impossible, as a rule, without filtering by a filter unit 5.

Here, a sample 21 of the process fluid 2 is taken by means of the withdrawal apparatus 3 and guided into the fluid line 4 connected to the withdrawal apparatus 3, with a first section 41 of the fluid line 4 being connected to the withdrawal apparatus 3. Here, taking a sample by means of the withdrawal apparatus 3 can be implemented in substantially automated fashion, for example in predetermined regular or irregular time intervals, during which a predetermined amount of sample is taken, for example. However, this may also relate to a substantially continuous sample withdrawal.

Following the sample being taken by the withdrawal apparatus 3, the sample 21 of the process fluid 2 is transported through the first section of the fluid line 41 and through the filter unit 5 by means of conveyor device 6 (a pump in this case), with this relating to a filter unit 5 with a membrane filter, for example. A filtered sample 22 of the process fluid 2 is obtained from the unfiltered sample 21 of the process fluid 2 by means of the filter unit 5, the solids having been substantially filtered out of said filtered sample. Subsequently, the filtered sample 22 is transported to the end section 421 of the second section 42 of the fluid line 4 by means of the conveyor device 6. Thus, the conveying direction of the sample 21, 22 of the process fluid 2 conveyed in the fluid line 4 is directed from the withdrawal apparatus 3 to the end section 421.

Here, the temperature of the sample 21, 22 is controlled by means of a temperature control device 7 in such a way that the temperature of the sample 21, 22 equals the process temperature PT during the entire conveyance from the withdrawal apparatus 3 to the end section 421. This causes the concentration of the substances Ck in the sample 21, 22 of the process fluid 2 also to substantially correspond to the concentration of the substances in the process, i.e., no substances are precipitated during the conveyance. This allows the filtered sample 22 to be supplied to an analysis appliance 110 in the end section 421, the analysis appliance 110 being an optical analysis appliance 110 in this case. Naturally, the analysis appliance 110 can also be embodied as a non-optical analysis appliance 110. Subsequently, the process of the process fluid 2 can be controlled and/or regulated on the basis of the measurement value of the optical analysis appliance (e.g., the concentration of an analyte).

In no way is the sample preparation device 1 according to the invention restricted to the embodiment shown here. By way of example, there are no restrictions in respect of the arrangement of the conveyor device 6 and/or the temperature control device 7 with respect to the filter unit 5, the withdrawal point 3 and the end section 421, or in respect of the arrangement of the conveyor device 6 and the temperature control device 7 with respect to one another. Naturally, other arrangements are possible. By way of example, the temperature control device 7 may have components arranged distributed along the fluid line, by virtue of, for example, the temperature control device 7 in this case comprising a plurality of active and/or passive temperature control elements 71, 72, e.g., active heating elements 71 or passive insulating elements 72, which are applied to different points on the fluid line 4 (see FIG. 1b). The conveyor device 6, too, can have components arranged distributed along the fluid line, such as, for example, a plurality of pumps 61, 62 arranged at different points of the fluid line.

FIG. 1b illustrates a further configuration of a sample preparation device 1 according to the invention, here as an example for a process fluid 2 with a process temperature of 90° C. The process fluid 2 is a mixture with two different salts (e.g., sodium chloride and potassium chloride) dissolved therein and with solid particles making the mixture turbid.

In this configuration, the sample preparation device 1 comprises a cleaning unit 10 in addition to the features illustrated in FIG. 1a. In this configuration, the temperature control device 7 has a plurality of active heating elements 71 that are arranged with an offset in the conveying direction. Further, a prefilter 12, which is used to filter out particularly coarse solid particles from the sample 21 of the process fluid 2, disposed upstream of the filter unit 5 is arranged in the first section 41 of the fluid line 4 and a measuring appliance 9 for determining and/or monitoring one or more measured variables of the sample 21, 22 is arranged in the first section 41 of the fluid line 4 and the second section 42 of the fluid line 4 in each case. The fluid line 4 relates to interconnected pipes or pipe sections.

Two measuring appliances 91, 92 are illustrated in exemplary fashion in FIG. 1b. By way of example, this can relate to a Coriolis flow measuring appliance and a pressure measuring appliance. The measuring appliances 91, 92 each are in contact with the sample 21, 22 by way of a measuring appliance region when determining and/or monitoring the measured variable of the sample 21, 22 of the process fluid 2, the measuring appliance region 91 being coated by a protective layer made of corrosion-resistant high-grade steel.

The conveyor device 6 for conveying the sample 21, 22 of the process fluid 2 has two speed regulated pumps 61, 62 in this case, said pumps being respectively arranged in the first section 41 of the fluid line 4 and in the second section 42 of the fluid line 4.

The process engineering procedures in the sample preparation device 1 can be monitored and controlled by means of the electronics unit 8, which controls and/or regulates the temperature control device 7 and which processes the measured values captured by the measuring appliances 9. By an appropriate actuation of the active elements of the temperature control device 7 and the conveyor device 6 and on the basis of the measured values, the electronics unit 8 controls the withdrawal and processing process carried out by the sample preparation device 1 in such a way that the temperature of the sample 21, 22 of the process fluid 2 substantially corresponds to the process temperature PT during the entire conveyance up to the end section 421. This ensures that, inter alia, the concentration of the cations and anions remains substantially constant during the conveyance from the withdrawal apparatus 3 and during the filtering in the filter unit 5. The withdrawal apparatus 3, the filter unit 5 and the conveyor device 6 are also actuatable by the electronics unit 8.

After prefiltering in a prefilter 12, the prefiltered sample 21 is conveyed by way of the first section 41 of the fluid line 4 into the filter unit 5, which has a membrane filter in this exemplary embodiment. Naturally, alternatively embodied filter units 5 are possible. Filtering in the filter unit 5 produces a portion of filtered sample 22 from the prefiltered sample 21, said portion of filtered sample being substantially free from turbidity and subsequently being guided from the filter unit 5 into the second section 42 of the fluid line 4 or to the end section 421 thereof. The filter unit 5 further comprises an outlet 51, by means of which a turbid portion of the sample 21 or filtered out solid particles that cause sample 21 to be turbid can be discharged. Preferably, the filter unit 5 is embodied as a self-cleaning filter unit 5. Clogging of the membrane filter is advantageously prevented in the case of the membrane filter by way of pressure-driven (back) flushing processes of the sample 21, 22 of the process fluid 2; differently configured filter units 5 can naturally also have a self-cleaning embodiment. As a result, no further cleaning of the filter unit 5 is necessary, in principle, during this sample taking mode.

In addition thereto, the first 41 and second section 42 of the fluid line 4 and the filter unit 5 can be cleaned by means of the cleaning unit 10, for example in the case of a planned interruption of the process or in the case of downtime of the process installation. To this end, the cleaning unit is connectable to the fluid line 4 by means of a valve unit 103 of the cleaning unit 10 arranged at the connection of the fluid line 4 and the further fluid line 102. Here, the valves of the valve unit 103 are also actuatable by the electronics unit 8. By way of an appropriate actuation of the valves of the valve unit 103 in a cleaning mode, the cleaning medium RM is guided from the reservoir 101 into the fluid line 4 and the filter unit 5 by way of the further fluid line 102. Once the cleaning medium has been guided from the further fluid line 102 into the fluid line 4 and the filter unit 5, it can either be guided back into the further fluid line 102 or else be guided out of the fluid line 4 via an outlet, for example via the outlet 51 of the filter unit 5 or via an outlet connected to the fluid line 4 by way of a further valve unit.

In the preferred embodiment shown here, the cleaning medium RM in the reservoir 101 is deionized or distilled water, for example, such that no residues of possible salts of the cleaning medium RM can accumulate in the fluid line 4, said salts, for instance, influencing the concentrations Ck1 and Ck2 in a sample taking mode following the cleaning mode. Here, the cleaning medium 10 is set to a cleaning temperature RT of 87° C. by means of an additional temperature control unit 104, which comprises a heating element in the reservoir 101 and an insulation element for the further fluid line 102, said cleaning temperature deviating from the process temperature PT by 3° C. and hence by less than 40° C., in particular by less than 5° C.

What this advantageously achieves is that there are almost no temperature differences in the fluid line 4 between the cleaning mode and the subsequent sample taking mode, as a result of which the temperature control of the sample 21, 22, conveyed in the sample preparation device 1, by means of the temperature control device 7 according to the invention is made easier.

Here, a cleaning agent RM2 can be added to the cleaning medium RM by means of a further valve of the valve unit 103. The added cleaning agent RM2 can be an acid, for instance citric acid, and it is contained in a cleaning agent reservoir 105. Here, the addition of the cleaning agent RM2 to the cleaning medium RM in the further fluid line 102 is metered by a metering unit 106 that is actuatable by the electronics unit 8, with metering of the cleaning agent RM2 being adjustable by way of the electronics unit 8. Naturally, for the case where the metering unit 106 is not actuatable by the electronics unit 8, the metering unit 106 can alternatively also be configured in such a way that, in the cleaning mode, the addition of the cleaning agent RM2 into the further fluid line 102 is metered independently in a predetermined fashion that is adjustable in the metering unit 106.

FIG. 2 shows an exemplary embodiment of an analysis device 11 according to the invention, in which a sample preparation device 1 according to the invention is connected to an analysis appliance 110 via the end section 421 that is suppliable to the analysis appliance 110. By way of example, the analysis appliance 110 has an optical measuring cell 111, by means of which the concentration Ck of at least one analyte, such as sodium Ck1 and potassium Ck2, contained in the sample 22 is measured in line. Here, the filtered sample 22 of the process fluid 2 is supplied to the measuring cell 111 via the end section 421. Here, a check as to whether the temperature in the measuring cell 111 corresponds to the process temperature PT is carried out by means of an optional and additional temperature measuring appliance 112 in the measuring cell 111. The measurement values captured in the measuring cell 111 and/or the temperature measured there are transferred to an overarching unit, such as a programmable logic unit, for example, which in turn is connectable to the electronics unit 8.

An outlet 113 is attached to an output of the analysis appliance 110, by means of which outlet it is possible to manually take a sample of the filtered sample 22 of the process fluid 2. Here, for example, the manually taken sample can be analyzed by means of a further analysis appliance that does not have an in-line configuration. A calibration, verification and/or adjustment of the in-line analysis appliance 110 can be carried out by means of the concentration of the analyte measured by the further analysis appliance.

### LIST OF REFERENCE SIGNS AND SYMBOLS

1 Sample preparation device

2 Process fluid

21 Sample of the process fluid

22 Filtered sample

3 Withdrawal apparatus

4 Fluid line

41, 42 First/second section of the fluid line

421 End section of the second section of the fluid line

5 Filter unit

51 Outlet

6 Conveyor device

61, 62 Pump

7 Temperature control device

71, 72 Active/passive temperature control elements

8 Electronics unit

9 Measuring appliance

91 Measuring appliance region

10 Cleaning unit

101 Reservoir

102 Further fluid line

103 Valve unit

104 Temperature control device

105 Cleaning agent reservoir

106 Metering unit

11 Analysis device

110 Analysis appliance

111 Measuring cell

112 Temperature measuring appliance

113 Outlet

112 Prefilter

PT Process temperature

Ck, Ck1, Ck2 Concentration of the substances

Cs Saturation concentration

TM Temperature the filtered sample in the measuring cell

RT Cleaning temperature

RM Cleaning medium

RM2 Cleaning agent

1. A sample preparation device for processing a sample of a process fluid,
said sample preparation device comprising:
a withdrawal apparatus for receiving the sample of the process fluid and a first section of a fluid line connected thereto;
a filter unit connected to the first section of the fluid line and to a second section of the fluid line, said filter unit being configured to filter the sample of the process fluid in such a way that the filtered sample of the process fluid is substantially free from turbidity, wherein the filter unit is arranged between the withdrawal apparatus and the second section of the fluid line;
a conveyor device, which is configured to convey the sample of the process fluid from the withdrawal apparatus to the filter unit by the first section of the fluid line and subsequently to convey said sample as a filtered process fluid from the filter unit to an end section of the second section of the fluid line by the second section of the fluid line, wherein the sample of the filtered process fluid is suppliable by the end section to an analysis appliance that is connectable to the end section;
and a temperature control device, wherein the temperature control device is configured to subject the sample of the process fluid to temperature control in such a way that the temperature of the sample of the process fluid remains substantially constant when conveyed through the fluid line and when filtered in the filter unit such that the temperature of the filtered sample in the end section that is connectable to the analysis appliance is substantially the same as a process temperature of the process fluid, which the process fluid has when the sample is taken; and
wherein the process fluid of the sample is a turbid solution with one or more substances dissolved therein.

2. The sample preparation device as claimed in claim 1,
wherein the process temperature of the process fluid in the process lies between 0° C. and 110° C.

3. The sample preparation device as claimed in claim 1,
wherein the temperature control device has actively heating temperature control elements and/or passive insulating temperature control elements for the purposes of keeping the temperature of the sample of the process fluid at the process temperature while conveying said sample of the process fluid.

4. The sample preparation device as claimed in claim 1,
comprising an electronics unit for open-loop and/or closed-loop control of the withdrawal apparatus, the filter unit, the conveyor device and/or the temperature control device.

5. The sample preparation device as claimed in claim 1,
wherein the solution is present as a virtually saturated solution, a substantially saturated solution or an oversaturated solution.

6. The sample preparation device as claimed in claim 1, wherein the conveyor device comprises
a pump arranged in the first section of the fluid line, and/or
a pump arranged in the second section of the fluid line.

7. The sample preparation device as claimed in claim 1, comprising:
at least one measuring appliance for determining and/or monitoring at least one measured variable of the sample of the process fluid conveyed through the fluid line, said measuring appliance being arranged between the withdrawal apparatus and the end section.

8. The sample preparation device as claimed in claim 7,
wherein at least one of the measuring appliances has a measuring appliance region,
and wherein the measuring appliance region is configured as being resistant to the sample of the process fluid.

9. The sample preparation device as claimed in claim 1,
wherein the filter unit is configured as substantially self-cleaning and comprises an outlet, by which the unfiltered and turbid sample of the process fluid is discharged.

10. The sample preparation device as claimed in claim 1, comprising:
a cleaning unit, which comprises at least one reservoir with a cleaning medium,
wherein a further fluid line is connected to the at least one reservoir, said further fluid line being connected to the fluid line by a valve unit connected to the further fluid line in such a way that the cleaning medium can be guided from the further fluid line into the fluid line and the filter unit.

11. The sample preparation device as claimed in claim 10,
wherein the cleaning medium is deionized water; and
wherein the cleaning unit comprises a temperature control device, by which the cleaning medium in the at least one reservoir and/or in the further fluid line is brought to a cleaning temperature, wherein the cleaning temperature deviates from the process temperature by no more than 40° C.

12. The sample preparation device as claimed in claim 10,
wherein the cleaning unit has a cleaning agent reservoir with a cleaning agent connected to the further fluid line.

13. The sample preparation device as claimed in claim 10,
comprising a prefilter arranged between the withdrawal apparatus and the filter unit.

14. An analysis device for determining a measured variable of a process fluid, said analysis device comprising:
a sample preparation device as claimed in claim 1,
furthermore comprising the analysis appliance connected to the end section,
wherein the analysis appliance is based on an optical measurement principle,
wherein the analysis appliance comprises a measuring cell for in-line determination and/or monitoring of at least one analysis measured variable of the filtered sample of the process fluid supplied to the analysis appliance via the end section,
and wherein the analysis measured variable comprises at least one concentration of said one or more substances dissolved in the process fluid.

15. The analysis device as claimed in claim 14,
wherein the analysis appliance comprises a temperature measuring appliance for determining and/or monitoring the temperature of the filtered sample of the process fluid in the measuring cell.

16. The analysis device as claimed in claim 15,
wherein the analysis device comprises an outlet for manually taking a sample of the filtered sample of the process fluid, said outlet adjoining the analysis appliance.

17. The sample preparation device as claimed in claim 1, wherein the one or more substances dissolved in said process fluid is at least one salt.

18. The sample preparation device as claimed in claim 5,
wherein concentration of one of the substances in the process fluid is at least 65% of the saturation concentration, and
wherein concentration of the one or more substances in the sample of the filtered process fluid corresponds to concentration of the one or more substances in an unfiltered sample of the process fluid.

19. The sample preparation device as claimed in claim 8,
wherein the measuring appliance region is coated with a protective coating, said protective coating in contact with the sample of the process fluid while determining and/or monitoring the measured variable; and
wherein the measuring appliance region coated with the protective coating is configured as being resistant to he sample of the process fluid.

20. The sample preparation device as claimed in claim 12,
wherein the cleaning unit comprises a metering unit for metering the cleaning agent supplied to the further fluid line, said metering unit connected between the further fluid line and the cleaning agent reservoir.
